(19) United States
(12) Patent Application Publication
(10) Pub. No.: US 2004/0036405 A1
(43) Pub. Date: Feb. 26, 2004

(54) Functional substance-containing screen for display devices and manufacturing method thereof

(75) Inventor: Gyu-hwan Hwang, Gyunggi-do (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/429,753

(22) Filed: May 6, 2003

(30) Foreign Application Priority Data
Aug. 26, 2002 (KR) 2002-50635

(51) Int. Cl. H01J 29/10

(52) U.S. Cl. 313/461

(57) ABSTRACT

A screen for display devices and manufacturing method thereof capable of enhancing optical characteristics as well as increasing customers' satisfaction through functional substances. The screen for display devices has a front panel formed by coating on the upper surface of a screen substrate a substance mixed with organic or inorganic functional fine particles. The organic or inorganic functional fine particles contain at least one or more functional substances for anti-bacteria, aroma, and deodorization. Further, the fine particles are encapsulated in predetermined sizes so as not to obstruct optical characteristics, and the capsules may be formed in circle-shaped, ellipse-shaped, or amorphous class 1-shaped grain sizes. In non-glare treatments, a convexoconcave-shaped front panel is formed to enhance optical characteristics by mixing a non-glare treatment substance and a fine particle-mixed substance.

### CROSS-REFERENCE TO RELATED APPLICATIONS

This application is based on Korean Application No. 2002-50635 filed Aug. 26, 2002, which is incorporated herein by reference in its entirety.

### BACKGROUND OF THE INVENTION

1. Field of the Invention

The present invention relates to a display device, and more particularly to a screen for the display device and manufacturing method thereof having functions of aroma, anti-bacteria, deodorization, and so on, in order to increase customer's satisfaction.

2. Description of the Prior Art

In general, screens for image display devices have optical lens-shaped, convexoconcave-shaped, and flat-type structures, among other structures, in order for users to have a far higher visual sensitivity for displayed images. That is, in consideration of a state that displayed characters and the like cannot be properly seen due to natural light or illuminating light which directly reaches the image display surface, on the screen is applied a ‘non-glare’ treatment process for preventing light reflections.

The ‘non-glare’ treatment refers to forming a convexoconcave-shaped screen by spraying the screen with fine glass particles for the purpose of alleviating the fatigue of users' eyes with reduced reflections of light coming from fluorescent lights or through windows. For reference, there are a silica coating method for scattering reflected light, an anti-reflection coating method for extinguishing reflection light, and so on, in ‘non-glare’ treatment methods.

Further, the above optical lens-shaped screen forwardly concentrates respective pixel lights irradiated thereto so that it can provide users with image quality of a visually improved feeling.

However, since the general screens or the above non-glare treated screens are all externally exposed, they can be polluted with bacterial substances such as dust and the like, causing a problem in that bacteria can be transferred to human bodies.

### SUMMARY OF THE INVENTION

In order to solve the above-mentioned problem, it is an aspect of the present invention to provide a screen for display devices and a manufacturing method thereof designed to be capable of carrying out functions of anti-bacteria, aroma, deodorization, and so on, depending on external environments, and of enhancing optical characteristics.

In order to achieve the above aspect, the screen for display devices according to the present invention comprises a screen substrate; and a front panel formed on the front of the screen substrate with a coating of a substance mixed with organic or inorganic functional fine particles.

The organic or inorganic functional fine particles contain at least one or more functional substances for anti-bacteria, aroma, and deodorization. Further, the fine particles are encapsulated in predetermined sizes so as not to obstruct optical characteristics, the capsules may be formed in circle-shaped, ellipse-shaped, or amorphous class 1-shaped grain sizes, and capsules formed in grain sizes in plural shapes may be used.

In the meantime, the front panel is formed with a uniform coating of the fine particles in a predetermined thickness on the front surface of the screen substrate. Further, the front panel, which is formed to be non-glare, has a convexoconcave shape thereon for improving optical characteristics through a mixture of the non-glare treatment substance and a fine particle-mixed substance.

Resin is used for the fine particle-mixed substance, a transparent and achromatic color is generally used for the fine particles or the resin, but the color characteristics can be given to the fine particles or the resin, and electrostatic prevention characteristics can be given to the fine particles or the resin.

In order to achieve the above aspect, the manufacturing method for the screen comprises the steps of coating a substance mixed with organic or inorganic functional fine particles on an upper surface of a screen substrate; and hardening a coating layer formed with the fine particle-mixed substance so coated.

In this case, a flow method, spray method, roll coating method, or the like may be used for the step for coating the fine particle-mixed substance on the screen substrate, and, of which, the spray method is preferable. Further, a natural drying, heat curing, ultra-violet (UV) curing method, or the like may be used for the step of hardening the coating layer, but, of which, the UV curing method is preferable.

The screen for display devices and manufacturing method thereof according to the present invention as above may contain a mixture of functional substances for aroma, deodorization, anti-bacteria, optical characteristics, and the like to perform aroma emissions and anti-bacteria functions in reactions of the fine particles to external frictions or external environment changes as the mixed substances are coated on the screen, have improved optical characteristics with a non-glare treatment, and have additional functionality of aroma emissions, anti-bacteria, deodorization, and so on, based on the functional substances.

### BRIEF DESCRIPTION OF THE DRAWINGS

The above-mentioned aspect and other features of the present invention will become more apparent by describing in detail an illustrative, non-limiting embodiment thereof with reference to the attached drawings, in which:

FIG. 1 is a cross-sectioned view for showing a screen for a display device according to an exemplary embodiment of the present invention; and

FIG. 2 is a cross-sectioned view for showing a screen for display devices according to another exemplary embodiment of the present invention.

### DESCRIPTION OF ILLUSTRATIVE, NON-LIMITING EMBODIMENTS

Hereinafter, the present invention is described in detail with reference to the accompanying drawings.

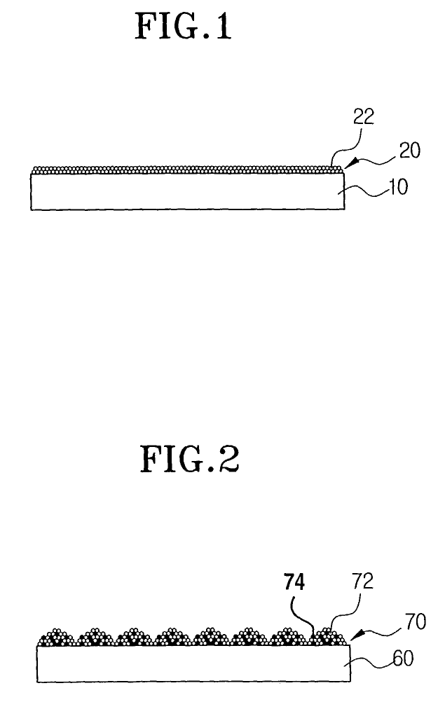

FIG. 1 is a cross-sectioned view for showing a screen for display devices according to an illustrative, non-limiting embodiment of the present invention. A screen has a screen substrate 10 and a front panel 20 formed on the upper surface of the screen substrate 10 and coated with resin mixed with functional substances.

In this case, the front panel 20 is formed on the front surface of the screen substrate 10, and on the front panel 20 is evenly coated a resin mixed with organic or inorganic fine particles 22 of functional substances. At this time, the functional fine particles 22 are formed with at least one or more functional substances capable of achieving the functions of aroma, anti-bacteria, deodorization, and so on, and have capsule shapes of a few nm˜μm in size. Specially, the capsules can be formed to be a few tens of μm in size. Further, the capsules can be formed in grain sizes in shapes such as circular shapes, ellipsoidal shapes, and amorphous class 1 shape, and capsules in diverse grain sizes can be simultaneously used.

In the meantime, a flow method, spray method, or roll coating method are generally employed for a method of coating the fine particles 22 on the upper surface of the screen substrate 10 in order to form the front panel 20, and, of which, the spray method is preferable in distributing fine particles 22.

Further, a natural drying, heat curing, or UV curing method, for example, can be used for hardening the front panel 20 on manufacturing screens, and, of which, the UV curing method is preferable in protecting the fine particles 22.

As stated above, organic or inorganic fine particles of functional substances such as aroma, deodorization, and anti-bacteria emit to externalize the internally contained functional substances with time lapses, due to external friction, or due to external environmental changes such as temperature, humidity, light source, and so on, and the functional substances are formed in sizes of a few nm˜a few μm or tens of μm, which is specially manufactured. That is, fine particles can naturally emit aroma based on time lapse, or based on their degradation due to surface friction as customers clean the screen surface, and so on. Further, in case that kids touch the screen, bacteria propagations are prevented due to anti-bacteria-characteristic fine particles.

FIG. 2 is a cross-sectioned view for showing a screen of display devices according to another illustrative, non-limiting embodiment of the present invention. Resin mixed with fine particles 72 of functional substances is coated to form convexoconcave shapes on the upper side 70 of the screen substrate 60 together with non-glare material 74 mixed with the resin.

As described above, the functions of aroma, anti-bacteria, deodorization, and so on can be provided together with optical characteristics enhancements by having the screen surface structurally convexoconcave with the fine particles 72 of circle-shaped grain sizes.

In the meantime, the achromatic and transparent color can be generally used for fine particles or resin in the above embodiment, and color characteristics can be given to fine particles and resin in order to enhance contrast characteristics. Further, it is also possible to give electrostatic characteristics to fine particles or resin.

Meanwhile, even though the above description has been made on the application of functional particles to a screen of display devices, the present invention, in addition to the display devices, can be applied to diverse structural products the appearances of which are exposed to external environments.

The screen for display devices and manufacturing method thereof as above according to the present invention are good for human bodies, can satisfy a variety of customers' preferences with an addition of functional substances such as aroma, anti-bacteria, deodorization, and so on, to the screens, as well as can satisfy customers' tastes while improving optical characteristics through the convexoconcave shape containing functional substances in case of non-glare treatments.

Although exemplary embodiments of the present invention have been described, it will be understood by those skilled in the art that the present invention should not be limited to the described exemplary embodiments, but various changes and modifications can be made within the spirit and scope of the present invention as defined by the appended claims.

What is claimed is:

1. A display device, comprising:
a screen substrate; and
a front panel formed on a front of said screen substrate with a coating of a substance mixed with at least one of organic and inorganic functional fine particles.

2. The display device as claimed in claim 1, wherein said fine particles contain at least one of the functional substances for anti-bacteria, aroma, and deodorization.

3. The display device as claimed in claim 2, wherein said fine particles are encapsulated in predetermined sizes.

4. The display device as claimed in claim 3, wherein said encapsulated fine particles are formed in circle-shaped grain sizes.

5. The display device as claimed in claim 4, wherein said front panel is formed with a uniform coating in a predetermined thickness on the front surface of said screen substrate.

6. The display device as claimed in claim 4, wherein said front panel further contains a non-glare treatment substance and has a convexoconcave shape thereon for improving optical characteristics through the non-glare treatment substance and a fine particle-mixed substance.

7. The display device as claimed in claim 3, wherein said encapsulated fine particles are formed a few tens of μm in size.

8. The display device as claimed in claim 1, wherein said substance comprises resin.

9. The display device as claimed in claim 8, wherein color characteristics are given to at least one of said fine particles and said resin.

10. The display device as claimed in claim 8, wherein electrostatic prevention characteristics are given to at least one of said fine particles and said resin.

11. A screen forming method for display devices, comprising the steps of:
coating a fine particle-mixed substance mixed with one of organic and inorganic functional fine particles on an upper surface of a screen substrate; and
hardening a coating layer formed with said fine particle-mixed substance.

12. The screen forming method as claimed in claim 11, wherein said fine particles contain at least one of the functional substances for anti-bacteria, aroma, and deodorization.

13. The screen forming method as claimed in claim 12, wherein said fine particles are encapsulated in predetermined circle-shaped grain sizes.

14. The screen forming method as claimed in claim 13, wherein said step of coating said fine particle-mixed substance is to uniformly coat said fine particle-mixed substance on the upper surface of the screen substrate.

15. The screen forming method as claimed in claim 13, wherein said step of coating said fine particle-mixed substance is to form a convexoconcave shape on the coating layer through a substance mixed with a non-glare substance and said fine particles.

16. The screen forming method as claimed in claim 11, wherein said step of hardening the coating layer uses an ultra-violet (UV) curing method.
